(19) United States
(12) Patent Application Publication
(10) Pub. No.: US 2024/0281007 A1
(43) Pub. Date: Aug. 22, 2024

(54) Method and Apparatus for Integrated Pressure and Flow Controller

(71) Applicant: MKS Instruments, Inc., Andover, MA (US)

(72) Inventors: Junhua Ding, Boxborough, MA (US); Michael L'Bassi, Sterling, MA (US)

(21) Appl. No.: 18/170,964

(22) Filed: Feb. 17, 2023

(51) Int. Cl. G05D 16/20

(52) U.S. Cl. CPC G05D 16/2013

(57) ABSTRACT

Pressure control methods and devices are provided. A pressure controller includes a control valve configured to control pressure of a fluid in a flow path, a flow restrictor disposed in the flow path, and distal and proximal pressure sensors. The distal pressure sensor detects fluid pressure at the flow restrictor at a location distal from the control valve, and the proximal pressure sensor detects fluid pressure at the flow restrictor at a location proximal to the control valve. The pressure controller further includes a controller configured to: 1) control actuation of the control valve based on pressure as detected by the distal pressure sensor and a pressure setpoint, and 2) determine a mass flow rate based on pressure as detected by the distal and proximal pressure sensors.

### BACKGROUND

Pressure controllers with integrated mass flow meters are used in critical process applications, such as backside wafer cooling, to provide for pressure measurement and control of a fluid while monitoring mass flow rates of the fluid. There exists a need for improved methods and devices for providing pressure control and monitoring of some process fluids.

### SUMMARY

Pressure controllers with integrated mass flow meters are provided which can advantageously be used to provide for pressure control and monitoring of reactive fluids, including reactive gases, such as O₃/O₂ mixtures.

A pressure controller includes a control valve configured to control pressure of a fluid in a flow path, a flow restrictor disposed in the flow path, and distal and proximal pressure sensors. The distal pressure sensor detects fluid pressure in the flow path at a location distal from the control valve, and the proximal pressure sensor detects fluid pressure in the flow path at a location proximal to the control valve. The flow restrictor is disposed in the flow path between the distal location and the proximal location. The pressure controller further includes a controller configured to control actuation of the control valve based on pressure as detected by the distal pressure sensor and a pressure setpoint and determine a mass flow rate based on pressure as detected by the distal and proximal pressure sensors.

A pressure controller includes a control valve configured to control pressure of a fluid in a flow path, a flow restrictor disposed in the flow path, and distal and proximal pressure sensors. The distal pressure sensor detects fluid pressure at the flow restrictor at a location distal from the control valve, and the proximal pressure sensor detects fluid pressure at the flow restrictor at a location proximal to the control valve. The pressure controller further includes a controller configured to control actuation of the control valve based on pressure as detected by the distal pressure sensor and a pressure setpoint. The controller is further configured to determine a mass flow rate based on pressure as detected by the distal and proximal pressure sensors.

A method of controlling pressure of a fluid includes controlling actuation of a control valve based on pressure detected by a distal pressure sensor and a pressure setpoint. The distal pressure sensor detects fluid pressure in a flow path at a location distal from the control valve. The method further includes determining a mass flow rate based on pressure as detected by the distal pressure sensor and a proximal pressure sensor that detects fluid pressure in the flow path at a location proximal to the control valve. A flow restrictor is disposed in the flow path between the distal location and the proximal location.

A method of controlling pressure of a fluid includes controlling actuation of a control valve based on pressure detected by a distal pressure sensor and a pressure setpoint. The control valve controls pressure of a fluid in a flow path, and a flow restrictor is disposed in the flow path. The distal pressure sensor detects fluid pressure at the flow restrictor at a location distal from the control valve. The method further includes determining a mass flow rate based on pressure as detected by the distal pressure sensor and a proximal pressure sensor that detects fluid pressure at the flow restrictor at a location proximal to the control valve.

The proximal and distal locations can be upstream of the control valve, so as to provide for upstream pressure control. Alternatively, the proximal and distal locations can be downstream of the control valve, so as to provide for downstream pressure control.

Controlling actuation of the control valve can include providing closed-loop feedback control of the control valve based on the pressure as detected by the distal pressure sensor and the pressure setpoint.

The mass flow rate Q of can be determined according to a function as provided by:

$$Q = f ( R , {P}_{u} , {P}_{d} , T , mw , μ , γ ) \qquad ( 1 )$$

where R is a characteristic of the flow restrictor, Pu is pressure upstream of the flow restrictor as detected by one of the distal and proximal pressure sensors, Pd is a pressure downstream of the flow restrictor as detected by the other of the distal and proximal pressure sensors, T is a temperature of the fluid, mw is a molecular weight of the fluid, μ is a viscosity of the fluid, and γ is a specific heat ratio of the fluid. The determined mass flow rate can be output.

A temperature of the fluid in the flow path can be detected. For example, a pressure controller can include a temperature sensor configured to detect a temperature of the fluid in the path. The temperature sensor can detect a temperature of the fluid at a location in the flow path at or close to the flow restrictor.

The fluid can be a reactive gas, such as, for example, an O₃/O₂ gas mixture or an HBr/Cl₂ gas mixture.

A pressure controller includes a control valve configured to control pressure of a fluid in a flow path, a flow restrictor disposed in the flow path, an upstream pressure sensor, and a downstream pressure sensor. The upstream pressure sensor detects fluid pressure at the flow restrictor upstream of the flow restrictor, and the downstream pressure sensor detects fluid pressure at the flow restrictor downstream of the flow restrictor. The pressure controller further includes a controller configured to control actuation of the control valve based on pressure as detected by one of the upstream and downstream pressure sensors and a pressure setpoint. The controller is further configured to determine a mass flow rate based on pressure as detected by the upstream and downstream pressure sensors.

A method of controlling pressure of a fluid includes controlling actuation of a control valve based on a pressure setpoint and pressure detected by one of an upstream pressure sensor and a downstream pressure sensor. The upstream pressure sensor detects fluid pressure at a flow restrictor upstream of the flow restrictor, and the downstream pressure sensor detects fluid pressure at the flow restrictor downstream of the flow restrictor. The control valve controls pressure of a fluid in a flow path, and the flow restrictor is disposed in the flow path. The method further includes determining a mass flow rate based on pressure as detected by the upstream and downstream pressure sensors.

The flow restrictor, upstream pressure sensor, and downstream pressure sensor can be disposed upstream of the control valve, with the one of the upstream and downstream pressure sensors being used as the pressure sensor for pressure control. Alternatively, the flow restrictor, upstream pressure sensor, and downstream pressure sensor can be disposed downstream of the control valve, with the one of the upstream and downstream pressure sensors being used as the pressure sensor for pressure control.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a schematic of a prior art pressure controller with integrated mass flow meter.

FIG. 2 is a schematic an example downstream-pressure controller with integrated mass flow meter.

FIG. 3 is a schematic of an example upstream-pressure controller with integrated mass flow meter.

FIG. 4 is a diagram illustrating a method of providing for pressure control and mass flow monitoring of a reactive gas.

### DETAILED DESCRIPTION

Pressure controllers with integrated mass flow meters can provide for pressure control of a fluid while monitoring a mass flow rate of the fluid for critical process applications (e.g., backside wafer cooling processes). Such pressure controllers can provide for both pressure control and mass flow rate monitoring in a compact package. Examples of pressure controllers include the General Purpose Downstream Pressure Controller with Mass Flow Meter (GPCMA) and High Performance Downstream Pressure Controller with Mass Flow Meter (PPCMA), by MKS Instruments, Inc. (Andover, MA).

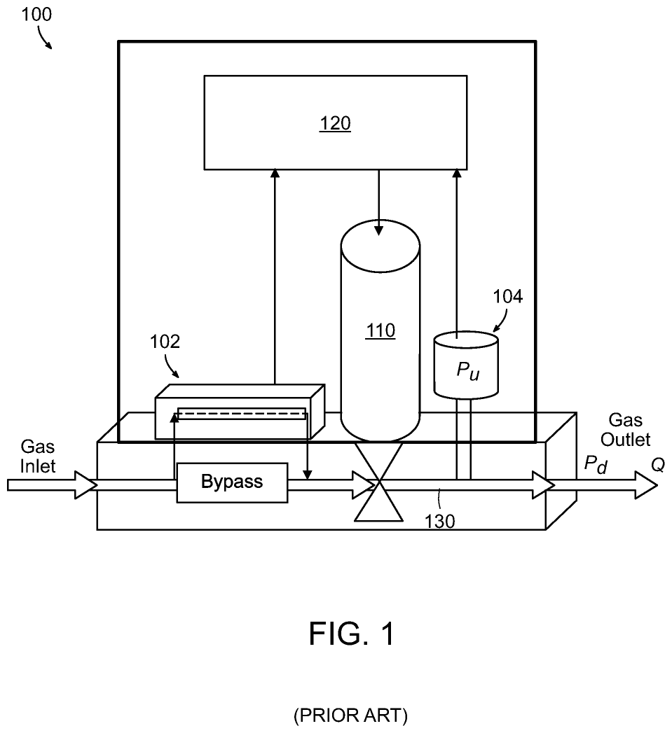

An example of a prior art pressure controller with integrated mass flow meter is shown in FIG. 1. The pressure controller 100 includes a thermal flow sensor 102, a control valve 110, and a pressure sensor 104. The pressure of a fluid flowing through a flow path 130 of the device is controlled by the control valve 110 based on a pressure as sensed by the pressure sensor 104. In particular, a controller 120, such as a micro-processor, can control actuation of the control valve 110 such that a monitored pressure (Pᵤ) is regulated to a pressure setpoint. As such, the pressure (P_{d}) of the fluid exiting the device is controlled to the pressure setpoint. Concurrently, the thermal flow sensor 102 provides for a measurement of the mass flow rate of the fluid. The mass flow rate and, optionally, the monitored pressure can be output by the device for reporting to a user.

Pressure controllers, such as pressure controller 100 of FIG. 1, are generally suitable for monitoring process gases; however, such pressure controllers can be unreliable and unsuitable for use with reactive gases. As used herein, a “reactive gas” is a gas or gas mixture that is unstable and/or exhibits high chemical reactivity. Examples of reactive gases include ozone (O₃), ozone-oxygen mixtures (O₃/O₂), and hydrogen bromide-chlorine gas mixtures (HBr/Cl₂).

Thermal flow sensors typically include a heat source, over which the gas being measured passes, and operate based on temperature measurements obtained of the gas. For example, a thermal flow sensor can include a sensor tube at which thermal elements are disposed. The thermal elements can be, for example, coiled resistors, which wrap around the sensor tube and are heated to a temperature above the ambient temperature. As gas flows through the sensor tube, the gas, which is typically at ambient temperature, has a cooling effect on the coils and lowers their temperature as a function of mass flow. The flowing gas cools an upstream coil more than a downstream coil and, thus, a mass flow rate of the gas can be determined based on a measured temperature difference between the coils, as indicated by a measured difference in resistances between the coils. Examples of thermal flow sensors are further described in U.S. Pat. No. 5,461,913.

The application of heat to a reactive gas and/or the generation of heat by exothermic reactions involving the reactive gas can interfere with thermal flow measurements. For example, with a process gas comprising ozone (O₃), inaccurate mass flow measurements may result from the thermal flow sensor 102 as ozone is unstable and releases heat as it decomposes. Furthermore, the application of heat to a gas comprising ozone can prompt the ozone to degrade. As such, signals from a thermal flow sensor are prone to saturate when used with ozone and other reactive gases. Furthermore, thermal flow sensors are prone to damage when used with reactive gases.

A description of example embodiments follows.

Pressure control devices and methods are provided which can be suitable for use with reactive gases. Such pressure control devices can further provide for both pressure control and mass flow rate monitoring in a compact format.

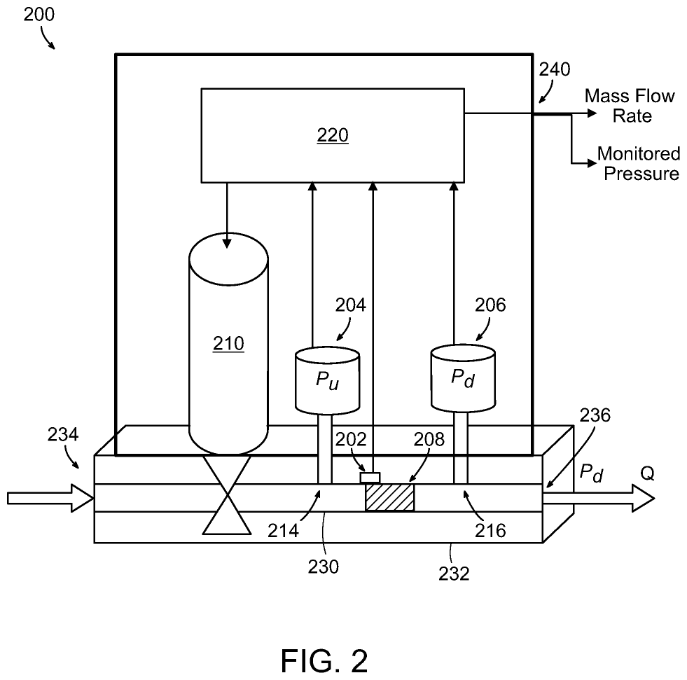

An example pressure controller is shown in FIG. 2. The pressure controller 200 includes a control valve 210 configured to control pressure of a fluid in a flow path 230. The flow path 230 can be defined by a body 232 the device. A flow restrictor 208 is disposed in the flow path 230. The device further includes pressure sensors 204, 206. The pressure sensor 204 is a proximal pressure sensor that detects fluid pressure in the flow path at a location 214 proximal to the control valve. The pressure sensor 206 is a distal pressure sensor that detects fluid pressure in the flow path at a location 216 distal from the control valve. A controller 220 controls actuation of the control valve 210 based on pressure as detected by the distal pressure sensor 206 and a pressure setpoint. The controller is further configured to determine a mass flow rate based on pressure as detected by the distal pressure sensor 206 and the proximal pressure sensor 204 (Pu and Pa). The pressure controller 200 can further include a temperature sensor 202. The temperature sensor 202 can be configured to detect a temperature of the fluid at or near the flow restrictor 208 for use with determining a mass flow rate of the fluid.

The pressure sensors 204, 206 can be configured to detect pressure at the flow restrictor 208. As used herein, “at” the flow restrictor means at an inlet or outlet of the flow restrictor, including at a location in the flow path that is adjacent to and sufficiently close to the inlet or outlet of the flow restrictor to provide for a pressure measurement that is usable in a mass flow rate determination. For example, a pressure sensor, or a portion thereof, can be disposed in the flow path such that it is beside the flow restrictor in the flow path.

As illustrated in FIG. 2, the pressure controller 200 is a downstream pressure controller, which controls pressure of the fluid flowing through the device based on a pressure measurement obtained downstream of the control valve 210 (P_{d}). As such, the pressure of the fluid exiting the device at an outlet 236 is controlled to the pressure setpoint. In this configuration, the pressure sensor proximal to the control valve (pressure sensor 204) is the upstream pressure sensor, which obtains a pressure reading upstream of the flow restrictor 208 (Pᵤ), and the pressure sensor distal from the control valve (pressure sensor 206) is the downstream pressure sensor, which obtains a pressure reading downstream of the flow restrictor 208 (P_{d}).

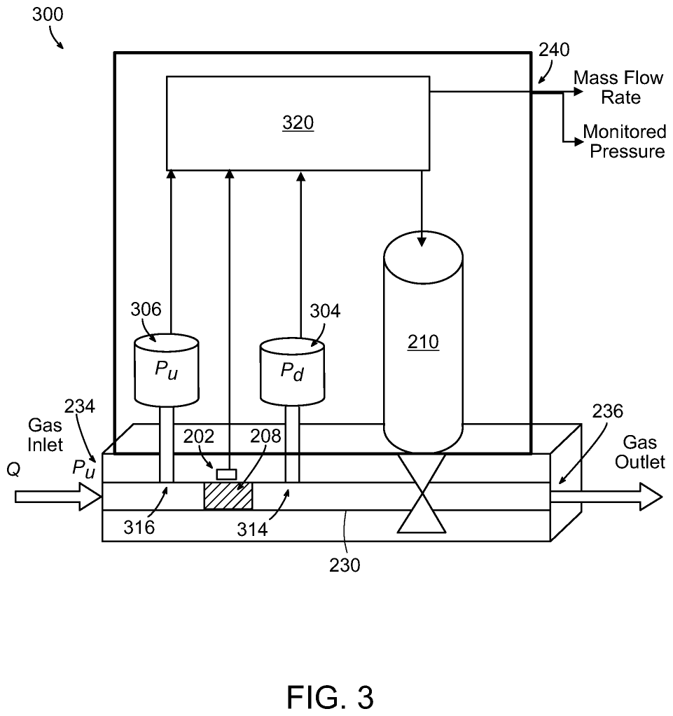

The pressure controller can alternatively be configured as an upstream pressure controller, as shown in FIG. 3. The pressure controller 300 includes elements similar to those shown with respect to the pressure controller 200, except that the pressures sensors 304, 306 are disposed upstream of the control valve 210. In this configuration, the pressure sensor distal from the control valve (pressure sensor 306) is the upstream pressure sensor, which detects fluid pressure in the flow path at a location 316 distal from the control valve, and the pressure sensor proximal to the control valve (pressure sensor 304) is the downstream pressure sensor, which detects fluid pressure in the flow path at a location 314 proximal to the control valve. The pressure of the fluid entering the device at inlet 234 is controlled to a pressure setpoint by the controller 220 based on pressure as sensed by the distal pressure sensor 306 (Pᵤ). The controller 320 is further configured to determine a mass flow rate based on the pressures as sensed by both pressure sensors 304, 306 (Pᵤ P_{d}).

In both the upstream and downstream configurations (200, 300), the pressure sensor distal from the control valve (pressure sensors 206, 306) advantageously provides for dual purpose use. In particular, the pressure as sensed by the distal pressure sensor is selected as the target for pressure control and is used by the controller (220, 320) to control actuation of the control valve 210 for controlling a pressure of the fluid at the downstream port (FIG. 2) or upstream port (FIG. 3). In addition, the pressure as sensed by the distal pressure sensor, in conjunction with the pressure as sensed by the proximal pressure sensor (pressure sensors 204, 304), is used by the controller (220, 320) to determine a mass flow rate of the fluid. Thus, the distal pressure measurement enables both pressure control and mass flow rate determination.

Control of the control valve 210 can be closed-loop. In particular, the controller (220, 320) can be configured to provide closed-loop feedback control of the control valve 210 based on the pressure as detected by the distal pressure sensor and a pressure setpoint. Actuation of the control valve can be based directly on the detected pressure. The detected pressure can be compared to the pressure setpoint, with an opening or closing of the valve modulated accordingly such that the distal pressure equals the pressure setpoint or is within an acceptable tolerance of the pressure setpoint. The distal pressure can be monitored throughout a pressure control process, with actuation of the control valve adjusted accordingly to maintain either upstream or downstream pressure control to the pressure setpoint.

As used herein, the term “control valve” refers to a valve that can provide for a controllable range of open states, likely between on and off states, and excludes on/off-type valves. The openness of an adjustable control valve can be controlled in response to a control signal, and a flow rate or pressure of fluid traveling through the valve can be controlled. Adjustable control valves include proportional control valves. Examples of suitable control valves for use as an adjustable control valve in the provided devices include solenoid valves, piezo valves, and step motor valves.

The mass flow rate (Q) of the fluid can be determined according to a function as provided by:

$$Q = f ( R , {P}_{u} , {P}_{d} , T , mw , μ , γ ) \qquad ( 1 )$$

where R is a characteristic of the flow restrictor, Pᵤ is pressure upstream of the flow restrictor as detected by one of the distal and proximal pressure sensors, P_{d} is a pressure downstream of the flow restrictor as detected by the other of the distal and proximal pressure sensors, T is a temperature of the fluid, mw is a molecular weight of the fluid, μ is a viscosity of the fluid, and γ is a specific heat ratio of the fluid. A characteristic of the flow restrictor (R) can be, for example, an orifice size of the restrictor. One or more flow restrictor characteristics can be considered when determining a mass flow rate according to Eqn. 1 (e.g., R can be representative or inclusive of more than one physical parameter of the flow restrictor). Properties of the fluid, including molecular weight, viscosity, and specific heat ratio, can be known values.

Methods of determining a mass flow rate of a fluid based on pressures sensed upstream and downstream of a flow restrictor are generally known in the art. The flow restrictor can be of any suitable type for restricting a flow of the fluid, including, for example, a critical flow nozzle, a laminar flow element, a porous media flow restrictor, an orifice, a valve, or a tube.

The controller 220, 320 can be configured to output the determined mass flow rate. For example, the pressure controller 200, 300 can include an output 240 for reporting the determined mass flow rate to another device, or the output 240 can be a display. While the pressure controller is configured to provide for pressure control of the fluid (e.g., not mass flow control to a mass flow setpoint), the monitored mass flow rate is valuable information for process monitoring and can be reported and/or used by other process devices. Optionally, the monitored pressure (e.g., as detected by the distal pressure sensor 206, 306) can also be output.

With use of proximal and distal pressure sensors, a pressure controller with integrated mass flow rate monitoring can be provided that is particularly suitable for use with reactive gases. The pressure sensors of the device can be capable of accurately reporting pressure of a reactive gas, which information can then be used to calculate a mass flow rate, whereas thermal flow sensors can be inaccurate with respect to such gases. Examples of suitable pressure sensors include Baratron® manometers (MKS Instruments, Inc.) and pressure transducers.

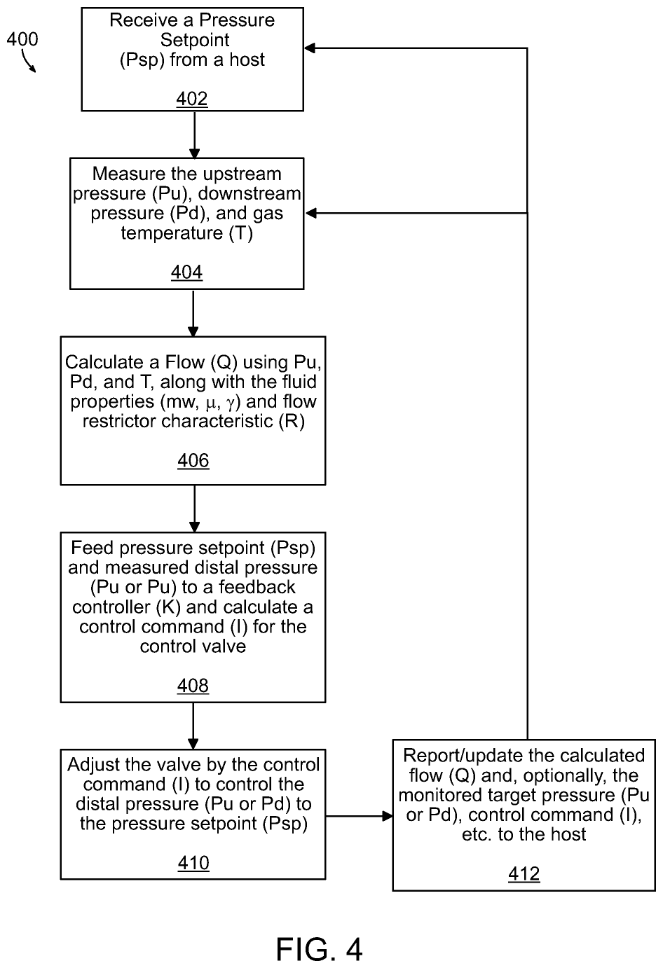

A flowchart illustrating operation of the pressure controller of either FIG. 2 or FIG. 3 is shown in FIG. 4. The process 400 begins with receipt of a pressure setpoint (Psp) from a host (402). The upstream pressure (Pu), downstream pressure (Pd), and gas temperature (T) are measured (404). A flow (Q) is calculated based on the measured values (406). The pressure setpoint (Psp) and measured distal pressure (either Pu or Pd, depending on whether the flow controller is in an upstream or downstream pressure control configuration) are provided to a feedback controller (K), which determines a control command (I) for the control valve (408). The control valve is adjusted by the control command (I) to control the distal pressure to the pressure setpoint (410). The flow (Q) is reported to the host, along with, optionally, the monitored target pressure (either Pu or Pd), and/or any other information (e.g., control command (I), the proximal pressure (either Pu or Pd), etc.)) (412). The process can repeat, with the pressures being continuously or periodically monitored for a given pressure setpoint, and/or upon receipt of a new pressure setpoint from the host. While the process 400 is shown in FIG. 4 with the flow calculation (406) as preceding the providing of a measured pressure to the feedback controller (408) and adjustment of the control valve (410), it should be understood that the flow calculation (406) can alternatively occur concurrently or subsequently to providing pressure feedback control (408, 410).

The provided methods and devices impart several improvements over existing methods and devices for providing pressure control with integrated mass flow measurement. The pressure-based flow measurements provided by the example devices and methods can be more reliable than those of prior art devices which rely on thermal-based flow measurements, particularly in reactive gas environments (e.g., O₃/O₂ mixtures). The provided devices can be more durable than prior art devices. With the dual use of one of the two pressure sensors (i.e., the pressure sensor distal from the control valve), a pressure controller can be provided that is compact and cost-effective.

The pressure sensors as shown in FIGS. 2 and 3 and the locations within the flow path at which the sensors obtain pressure measurements are generally described as “proximal” and “distal” based on proximity to the control valve of the device. A “distal pressure sensor” and/or “distal location” within the flow path can be to a side of the flow restrictor that is farthest from the control valve. A “proximal pressure sensor” and/or a “proximal location” within the flow path can be to a side of the flow restrictor that is closest to the control valve.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A pressure controller comprising:
a control valve configured to control pressure of a fluid in a flow path;
a flow restrictor disposed in the flow path;
a distal pressure sensor that detects fluid pressure at the flow restrictor at a location distal from the control valve;
a proximal pressure sensor that detects fluid pressure at the flow restrictor at a location proximal to the control valve; and
a controller configured to:
control actuation of the control valve based on pressure as detected by the distal pressure sensor and a pressure setpoint, and
determine a mass flow rate based on pressure as detected by the distal and proximal pressure sensors.

2. The pressure controller of claim 1, wherein the proximal and distal locations are upstream of the control valve.

3. The pressure controller of claim 1, wherein the proximal and distal locations are downstream of the control valve.

4. The pressure controller of claim 1, wherein the controller is configured to provide closed-loop feedback control of the control valve based on the pressure as detected by the distal pressure sensor and the pressure setpoint.

5. The pressure controller of claim 1, wherein the controller is configured to determine the mass flow rate Q as according to a function as provided by:
$$Q = f ( R , {P}_{u} , {P}_{d} , T , mw , μ , γ )$$
where R is a characteristic of the flow restrictor, Pᵤ is pressure upstream of the flow restrictor as detected by one of the distal and proximal pressure sensors, P_{d} is a pressure downstream of the flow restrictor as detected by the other of the distal and proximal pressure sensors, T is a temperature of the fluid, mw is a molecular weight of the fluid, μ is a viscosity of the fluid, and γ is a specific heat ratio of the fluid.

6. The pressure controller of claim 1, wherein the controller is further configured to output the determined mass flow rate.

7. The pressure controller of claim 1, further comprising a temperature sensor that detects temperature of the fluid in the flow path.

8. The pressure controller of claim 1, wherein the fluid is a reactive gas.

9. A method of controlling pressure of a fluid, comprising:
controlling actuation of a control valve based on pressure detected by a distal pressure sensor and a pressure setpoint, the control valve controlling pressure of a fluid in a flow path, the distal pressure sensor detecting fluid pressure at a flow restrictor at a location distal from the control valve, the flow restrictor disposed in the flow path; and
determining a mass flow rate based on pressure as detected by the distal pressure sensor and a proximal pressure sensor that detects fluid pressure at the flow restrictor at a location proximal to the control valve.

10. The method of claim 9, wherein the proximal and distal locations are upstream of the control valve.

11. The method of claim 9, wherein the proximal and distal locations are downstream of the control valve.

12. The method of claim 9, wherein controlling actuation of the control valve includes providing closed-loop feedback control of the control valve based on the pressure as detected by the distal pressure sensor and the pressure setpoint.

13. The method of claim 9, wherein determining the mass flow rate Q is according to a function as provided by:
$$Q = f ( R , {P}_{u} , {P}_{d} , T , mw , μ , γ )$$
where R is a characteristic of the flow restrictor, Pᵤ is pressure upstream of the flow restrictor as detected by one of the distal and proximal pressure sensors, P_{d} is a pressure downstream of the flow restrictor as detected by the other of the distal and proximal pressure sensors, T is a temperature of the fluid, mw is a molecular weight of the fluid, μ is a viscosity of the fluid, and γ is a specific heat ratio of the fluid.

14. The method of claim 9, further comprising outputting the determined mass flow rate.

15. The method of claim 9, further comprising detecting a temperature of the fluid in the flow path.

16. The method of claim 9, wherein the fluid is a reactive gas.

17. A pressure controller comprising:
a control valve configured to control pressure of a fluid in a flow path;
a flow restrictor disposed in the flow path;
an upstream pressure sensor that detects fluid pressure at the flow restrictor upstream of the flow restrictor;
a downstream pressure sensor that detects fluid pressure at the flow restrictor downstream of the flow restrictor; and
a controller configured to:
control actuation of the control valve based on pressure as detected by one of the upstream and downstream pressure sensors and a pressure setpoint, and
determine a mass flow rate based on pressure as detected by the upstream and downstream pressure sensors.

18. The pressure controller of claim 17, wherein the flow restrictor, upstream pressure sensor, and downstream pressure sensor are disposed upstream of the control valve, the one of the upstream and downstream pressure sensors being the upstream pressure sensor.

19. The pressure controller of claim 17, wherein the flow restrictor, upstream pressure sensor, and downstream pressure sensor are disposed downstream of the control valve, the one of the upstream and downstream pressure sensors being the downstream pressure sensor.

20. A method of controlling pressure of a fluid, comprising:
controlling actuation of a control valve based on a pressure setpoint and pressure detected by one of an upstream pressure sensor and a downstream pressure sensor, the upstream pressure sensor detecting fluid pressure at a flow restrictor upstream of the flow restrictor, the downstream pressure sensor detecting fluid pressure at the flow restrictor downstream of the flow restrictor, the control valve controlling pressure of a fluid in a flow path, the flow restrictor disposed in the flow path; and
determining a mass flow rate based on pressure as detected by the upstream and downstream pressure sensors.

21. The method of claim 20, wherein the flow restrictor, upstream pressure sensor, and downstream pressure sensor are disposed upstream of the control valve, the one of the upstream and downstream pressure sensors being the upstream pressure sensor.

22. The method of claim 21, wherein the flow restrictor, upstream pressure sensor, and downstream pressure sensor are disposed downstream of the control valve, the one of the upstream and downstream pressure sensors being the downstream pressure sensor.
